(19) United States
(12) Patent Application Publication
(10) Pub. No.: US 2016/0121518 A1
(43) Pub. Date: May 5, 2016

(54) DRIVE AND SYSTEM HAVING AT LEAST ONE DRIVEN CYLINDER OR EXTRUDER SCREW

(71) Applicant: STARLINGER & CO GESELLSCHAFT M.B.H, Wien (AT)

(72) Inventor: Harald HÖLLER, Haslach (AT)

(73) Assignee: Starlinger & Co Gesellschaft M.B.H., Wien (AT)

(21) Appl. No.: 14/889,776

(22) PCT Filed: Apr. 9, 2014
(86) PCT No.: PCT/EP2014/057110

§ 371 Date: Nov. 6, 2015

(30) Foreign Application Priority Data
May 10, 2013 (EP) 13167232.1

(51) Int. Cl. B29C 33/04; B29C 43/52; B29C 43/24; B29C 43/46; B29C 47/08; B29C 47/80

(52) U.S. Cl. CPC B29C 33/044; B29C 47/0801; B29C 47/805; B29C 43/24; B29C 43/46; B29C 43/52

(57) ABSTRACT

A drive (20) for a roller (30) or screw has a drive shaft (1) and an electric drive motor (18) having a rotor (6) and a stator (5). The rotor (6) is non-rotatably connectable to the drive shaft (1). The drive shaft (1) is connected non-rotatably to the roller or screw at a connection end (1a). The stator (5) is non-rotatably retained by a stationary component of the drive. The rotor (6) is mounted axially rotatably on a motor housing (7) with a motor bearing (8) facing the connection end (1a) of the drive shaft and with a motor bearing (9) facing away from the connection end (1a) of the drive shaft. The drive shaft (1) is guided coaxially to the rotor (6) through the drive motor (18) and beyond the drive motor (18), where the drive shaft has a free end (1b). The drive shaft is configured as a hollow shaft having an axial tempering medium channel (1c), which is coupled at the free end (1b) of the drive shaft to a tempering medium connection (12, 13).

Smoothing cylinders or rolls, respectively, as well as calender rolls have been known for a long time and serve for the production of flat foil webs as well as plates, in particular made from plastic materials, for the further processing in thermoforming plants. For the production of flat foil webs there is frequently used an arrangement of several smoothing rolls, wherein these smoothing rolls are usually configured with coolant channels in order to enable rapid cooling of the product or the melt, respectively.

There is further known to operate such rollers at a relatively low number of revolutions in the range from 1 to 500 rpm. As conventional electric drive motors usually have higher numbers of revolutions or cannot be operated in an optimum way in the mentioned ranges of low revolution numbers, respectively, it is necessary to reduce the number of revolutions in the form of a conventional gear set, chain drive or belt drive or a combination of these. It is known that mechanic gear sets as well as chain drives due to gearing typically have a tolerance, which is reflected in so-called chatter marks in the product and which negatively affects the foil quality that may be achieved. It is further known that belt drives in addition have a slip, which also has negative consequences for the product.

Gear sets as well as chain and belt drives additionally present challenges in regard to safety, lubrication and maintenance, which in operation will be disadvantageous in regard to hazard potential and operational costs.

It is further known that, in the case of smoothing rolls, the number of revolutions of the rollers has to be exactly determined in operation for reasons of quality assurance, which is why impulse transmitters, e.g., in the form of an encoder, are attached at the motor output shaft.

Recent embodiments of the drive train of smoothing rolls and the like are equipped with so-called direct drives, wherein the motor is directly connected to the drive shaft of the smoothing roll, whereby the interposed gear sets or chain or belt drives, respectively, are omitted.

From the EP 1 340 608 A there is known a plastic foil smoothing device having a smoothing roll and a direct smoothing roll drive. The smoothing roll drive is composed of a drive housing and a drive motor having a stator and a rotor. In the drive housing the cylinder-like stator and the cylinder-like rotor are arranged coaxially with each other, wherein the stator surrounds the rotor. The rotor is connected to a drive shaft of the smoothing roll without an interposed gear set, wherein the cylinder-like rotor surrounds a part of a connecting sleeve configured as a hollow cylinder, to which the rotor is fixed non-rotatably, wherein the drive shaft of the smoothing roll is connected non-rotatably with the connecting sleeve. This smoothing system having a direct drive is disadvantageous insofar as the motor is mounted only once and, hence, the rotor thereof can only perform revolutions, if it sits in a correct position on the drive shaft of the smoothing roller. This, however, is difficult to realize in an on-site-mounting due to the high magnetic forces in the motor. In particular such an embodiment is prone to misalignment of motor and drive shaft affecting the bearing.

Another main task of smoothing, casting, calender or cooling rolls is the cooling of the product. For this reason, a liquid or gaseous coolant is guided through cooling channels integrated in the roll, thus guaranteeing discharge of the thermal energy introduced into the rolls by the product. The connection to a coolant supply is realized by means of so-called rotary feedthroughs. Due to the configuration of conventional direct drives, in particular the arrangement of the impulse transmitter, it is necessary to provide a rotary 2-way-feedthrough. Due to the necessary cooling performance, there is achieved a minimum flow area of the cooling channels, which has to be present at the shaft end, at which the rotary feedthrough is situated, in duplicate (supply and return system) and which influences the dimensioning of the shaft end and, hence, the shaft bearing insofar as either the bearing at both ends has to be over-dimensioned accordingly and, hence, is expensive, or it is necessary an asymmetric bearing, this means not equally sized bearings at both shaft ends. Asymmetric bearings have further disadvantages in regard to not-uniform wear and increase of the number of different replacement components. Further the production costs for the necessary rotary 2-way-feedthroughs in regard to the coolant flow rate are essentially higher than with rotary 1-way-feedthroughs. According to principle, rotary 2-way-feedthroughs are also more complex in sealing against the environment and within the two coolant paths, whereby the maintenance costs in comparison thereto are higher. Another disadvantage is that the necessary motor cooling can only be realized via the exterior shell of the drive and that therefore a higher winding temperature will be developed in the motor, which in turn will be reflected in a shorter life time of the drive.

The present invention is based on the task to provide a direct drive, which does not show the disadvantages of prior art explained above.

The present invention is further based on the task to provide a system having cooling rolls, casting rolls, rollers, smoothing rolls, calender rolls and/or stretching rolls, wherein at least some of the rolls mentioned are equipped with a direct drive, which does not show the disadvantages of prior art explained above.

It is in particular a task of the invention to provide a drive, which, apart from the transmission of the necessary drive torque, in addition serves as a transport support for liquid or gaseous coolants or heating media.

In a further aspect the invention relates to an extruder having at least one heated or cooled extruder screw. Such extruders underlie the same problems as the known smoothing systems having smoothing rolls that are explained above. The present invention, hence, is also based on the task to provide an extruder screw of such an extruder with a direct drive, which does not show the disadvantages of prior art of conventional extruder drives, which are mentioned above.

The invention solves the tasks set by providing a drive having the features of claim 1 as well as by providing a system having at least one cooling roll, cast roll, roller, smoothing roll, calender roll and/or stretching roll or an extruder having an extruder screw, wherein at least one roll or extruder screw, respectively, is connected to an drive according to the present invention.

The drive according to the present invention for a roller or screw includes a drive shaft and an electric drive motor having a rotor and a stator surrounding the rotor. The rotor is non-rotatably connectable or connected, respectively, to the drive shaft. The drive shaft is non-rotatably coaxially connected at a connection end with the roller or the screw, wherein the term “connected” also includes that the drive shaft is integrally formed with the roller or the screw. The stator is retained non-rotatably by a stationary component of the drive. The rotor is mounted axially rotatably on a motor housing with a motor bearing facing the connection end of the drive shaft and with a motor bearing facing away from the connection end of the drive shaft. The drive shaft is guided coaxially to the rotor through the drive motor and beyond the drive motor at the side facing away from the connection end of the drive shaft, where the drive shaft has a free end. The drive shaft is configured as a hollow shaft having an axial tempering medium channel, which is coupled at the free end of the drive shaft to a tempering medium connection.

The drive according to the present invention for a roller or screw has the big advantage that the rotor can rotate freely, even if it is not connected to the drive shaft. This enables a simple attachment and replacement on site, without geometric settings of the position of the rotor in regard to the drive shaft, which are complicated and difficult to realize at the installation, having to be performed. The drive according to the present invention is essentially more durable than known direct drives, as the geometric requirements can be complied to more exactly than with prior art, whereby bearing stress is significantly reduced. Furthermore, the influence of component tolerances will become lower than with prior art.

In some roller systems, in particular also with extruders, the rollers or the extruder screw, respectively, are mounted only one-sided on the side of the drive. In such embodiments the two-sided mounted drive can offer additional stability for the drive shaft.

As the drive shaft is configured as a hollow shaft, which has an axial tempering medium channel, which is coupled at the free end of the drive shaft to a tempering medium connection, it is possible to retain the motor within a desired operational temperature range by means of the tempering medium.

If the tempering medium channel of the drive shaft is coupled at least to a tempering medium channel of the roller or screw, then tempering medium flowing through the tempering medium channel of the drive shaft can retain the roller or the screw within a desired operational temperature range.

In a preferred embodiment the tempering medium connection is configured as a rotary 1-way-feedthrough, whereby the diameter of the drive shaft may be reduced and symmetric motor bearings may be used. The feed or discharge of the gaseous or liquid tempering medium is realized through the rotary 1-way-feedthrough, with the discharge or feed of the tempering medium being realized through the tempering channels of the roller or screw.

In spite of the advantages of rotary 1-way-feedthroughs described it may be favourable with some applications of the drive according to the present invention if the tempering medium connection is configured as a rotary 2-way-feedthrough having a supply and return system. This is especially true for extruders, wherein it is not possible to provide the exit-sided end of the extruder screw with a tempering medium connection. On the other hand, the diameter of the drive shaft of extruder screws is usually so large that the larger configuration of rotary 2-way-feedthroughs can be accepted.

According to a further aspect of the invention the flow direction of the tempering medium into or out of, respectively, the tempering medium channel of the drive shaft is switchable. This may, for example, be used to protect the motor against the formation of condensate in the case of cold ambient conditions.

As in the drive according to the present invention the drive shaft has a free end, it is possible to provide an impulse transmitter surrounding the drive shaft in order to monitor the rotary speed of the drive shaft and, hence, the roller or screw connected thereto. This ring-like arrangement of the impulse transmitter, which is, e.g., mounted at a motor bearing, does not enlarge the configuration of the drive and does not hamper—in contrast to axial impulse transmitter arrangements in prior art—the end-sided installation of a rotary feedthrough for the tempering medium.

In a preferred embodiment of the drive according to the present invention the stator is non-rotatably connected to the motor housing and the motor housing is non-rotatably connectable to precisely one stationary support. This facilitates the simple replacement of the motor on site, without complicated adjustment works having to be performed, and it guarantees a secure and geometrically aligned position of the drive motor. If the motor housing is connected to the fixed support via an interposed elastic buffer element, component tolerances are compensated and bearing tensions are prevented.

For a connection, which may be handled quickly on site but, however, still is reliable and may be realized using only a few components and is not space-consuming, between the rotor and the drive shaft there is further provided that the rotor is connected to the drive shaft by means of a clamping device arranged on the shell surface of the drive shaft. The clamping device enables a central, backlash-free connection between rotor and drive shaft.

In order to maintain the coaxial arrangement of rotor and drive shaft there is used a fitting sleeve between the rotor and the drive shaft, which is arranged on the side of the free end of the drive shaft.

The invention is now explained in detail by way of an exemplary embodiment in regard to the drawings. In the drawings:

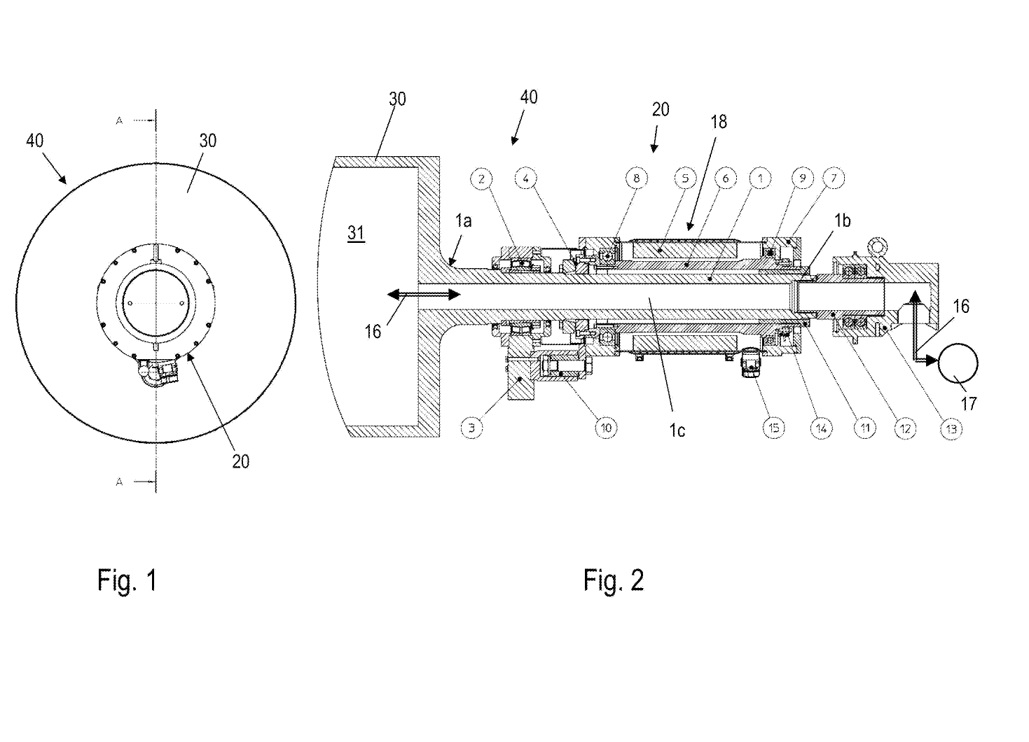

FIG. 1 shows a front view of a system having a roller and an direct drive of the roller according to the present invention; and

FIG. 2 shows a sectional view along the line A-A of FIG. 1.

FIG. 1 shows a system 40 having a roller 30 and a drive 20. The roller 30 is configured either as a cooling roll, a cast roll, a smoothing roll, a calender roll or a stretching roll. Alternatively to the roll, there could also be provided an extruder having an extruder screw driven by the drive 20.

The drive includes a drive shaft 1 and an electric drive motor 18 having a rotor 6 and stator 5 coaxially surrounding the rotor, which stator 5 has windings. The rotor 6 is connected non-rotatably to the drive shaft 1 by means of a clamping device 4 arranged on the shell surface of the drive shaft 1. The clamping device 4 is configured as a conical tensioning element for the friction-fit and, hence, backlash-free assembly. The drive shaft 1 is integral with a connection end 1a and, hence, non-rotatably integrated in the roller 30. The stator 5 is non-rotatably retained by being non-rotatably connected to the motor housing 7 and by the motor housing being non-rotatably connected to precisely one stationary support 3. The reason why the motor housing 7 is connected with the support 3 only at one position is the prevention of tensions, which would develop in the case of a multi-connection. Further an elastic buffer element 10 is interposed between the motor housing 7 and the stationary support 3. By attachment of the motor housing 7 at the support 3, the torque introduced by the motor provides for a rotational movement of the drive shaft 1. Said support 3 usefully serves in addition for housing a drive-sided roller bearing 2. In some systems having rollers or extruders, the roller or the extruder screw, respectively, is only mounted by a drive-sided roller bearing 2, whereas in other systems the roller or extruder screw, respectively, is mounted twice or multiple times.

The rotor 6 is double-mounted so as to be axially rotatable on the motor housing 7, on the one side by way of a motor bearing 8 facing the connection end 1a of the drive shaft and, on the other side, with a motor bearing 9 facing away from the connection end 1a of the drive shaft. Both motor bearings 8, 9 are configured as roll bearings. The drive shaft 1 is guided coaxially to the rotor 6 through the drive motor 18 and beyond the drive motor on the side facing away from the connection end 1a of the drive shaft, where the drive shaft leads To a free end 1b. A fitting sleeve 11 arranged at the free end 1b between the rotor 6 and the drive shaft 1 is intended for coaxial central alignment.

The drive shaft 1 is configured as a hollow shaft having an axial tempering medium channel 1c, which is coupled at the free end 1b of the drive shaft to a tempering medium connection 12, 13, via which a liquid or gaseous tempering medium 16, this is a coolant and/or heating medium such as, e.g., water, may be introduced into and/or discharged from the tempering medium channel 1c by means of a pump 17. In this way, the heat developing in the drive 20 can be discharged directly via the tempering medium 16. The tempering medium channel 1c of the drive shaft 1 is coupled to a tempering medium channel 31 of the roller 30 in a way so that the tempering medium 16 can flow into and out of the tempering medium channel 31 of the roller 30. The tempering medium connection is configured in two parts and has a rotary 1-way-feedhrough 12, which is sealingly connected to the tempering medium channel 1c and which rotates coaxially with the drive shaft 1. The opposite end of the rotary 1-way-feedthrough 12 ends into a stationary housing 13, which has an inlet for the tempering medium 16. The flow direction of the tempering medium 16 into or out of, respectively, the tempering medium channel 1c of the drive shaft 1 is preferably switchable, for example by reversal of the feeding direction of the pump 17. In some applications, in particular with extruders, there may also be provided a rotary 2-way-feedthrough having a supply and return system for the tempering medium 16.

Over the shell surface of the drive shaft 1, in particular at the rotor 5 near the motor bearing 9, there is situated an impulse transmitter 14 in the form of a ring-like hollow shaft encoder, which surrounds the drive shaft 1 like a ring and transmits information about the number of revolutions of the drive shaft 1 via the electric connection 14 of the drive 20 to a machine control not depicted.

1. A drive for a roller or screw, comprising a drive shaft and an electric drive motor having a rotor and having a stator surrounding the rotor, wherein the rotor is non-rotatably connectable to the drive shaft, the drive shaft is non-rotatably and coaxially connected to the roller or screw at a connection end and the stator is non-rotatably retained by a stationary component of the drive, and wherein the rotor is mounted axially rotatably on a motor housing with a motor bearing facing the connection end of the drive shaft and with a motor bearing facing away from the connection end of the drive shaft, and the drive shaft is guided coaxially to the rotor through the drive motor and beyond the drive motor at the side facing away from the connection end of the drive shaft, where the drive shaft has a free end, wherein the drive shaft is configured as a hollow shaft having an axial tempering medium channel, which is coupled at the free end of the drive shaft to a tempering medium connection.

2. The drive according to claim 1, wherein the tempering medium channel of the drive shaft is connectable to at least one tempering medium channel of the roller or screw.

3. The drive according to claim 2, wherein the tempering medium connection is configured as a rotary 1-way-feedthrough.

4. The drive according to claim 2, wherein the tempering medium connection is configured as a rotary 2-way-feedthrough.

5. The drive according to claim 1, wherein the flow direction of the tempering medium into or out of, respectively, the tempering medium chancel of the drive shaft is switchable by a pump.

6. The drive according to claim 1, wherein an impulse transmitter surrounds the drive shaft.

7. The drive according to claim 1, wherein the stator is connected non-rotatably to the motor housing and the motor housing is non-rotatably connectable to precisely one stationary support.

8. The drive according to claim 7, wherein the motor housing is connected with the stationary support via an intermediary elastic buffer element.

9. The drive according to claim 1, wherein the rotor is connected to the drive shaft by means of a clamping device arranged on a shell surface of the drive shaft.

10. The drive according to claim 1, wherein a fitting sleeve is arranged between the rotor and the drive shaft.

11. A system having at least one cooling roller, casting roll, roll, smoothing roll, calender roll and/or stretching roll, wherein at least one roller is connected to a drive shaft of a drive according to claim 1.

12. An extruder having an extruder screw, wherein the extruder screw is connected to a drive shaft of a drive according to claim 1.
